(19) United States
(12) Patent Application Publication
(10) Pub. No.: US 2014/0023814 A1
(43) Pub. Date: Jan. 23, 2014

(54) POTABLE WATER CONTAINERS HAVING SURFACES INCLUDING HEAT LABILE COMPONENT/CARRIER COMBINATIONS AND METHODS FOR THEIR PREPARATION

(71) Applicants: Frank M. Fosco, JR., Plainfield, IL (US); Edward E. Sowers, Plainfield, IN (US)

(72) Inventors: Frank M. Fosco, JR., Plainfield, IL (US); Edward E. Sowers, Plainfield, IN (US)

(21) Appl. No.: 13/729,748

(22) Filed: Dec. 28, 2012

Related U.S. Application Data
(60) Provisional application No. 61/580,774, filed on Dec. 28, 2011.

(51) Int. Cl. C08K 5/544; C08K 5/3432; C08K 5/17; C08K 3/36

(52) U.S. Cl. CPC C08K 5/544; C08K 3/36; C08K 5/3432; C08K 5/17
USPC 428/36.92; 523/122; 106/170.1; 106/170.42; 106/170.2

(57) ABSTRACT

Containers for the storage and/or transport of potable water having surfaces derived from a range of polymers are provided. The container's surfaces may include a component/carrier combination (typically a heat labile component) which affords thermal stability to the surface containing the component. The component/carrier combination enables a heat labile component to survive exposure to elevated temperatures greater than its decomposition or volatilization temperature during processing or during the container's service. Additionally, the use of a component/carrier combination allows a plurality of otherwise incompatible components to be included within a single formulation. The different components included in the surface are able to impart a range of properties to the container's surface. Components can include, but are not limited to bacteriocides, fungicides, algaecides, viruscides, insecticides, antibiotics, enzymes, repellents (animal and insect), herbicides, pheromones, molluscicides, acaricides, miticides, rodenticides, fragrances, and the like. Methods for preparing the polymer/component/carrier combination are also provided.

### CROSS-REFERENCE TO RELATED APPLICATIONS

This application claims priority to U.S. Provisional Patent Application No. 61/580,774 filed on Dec. 28, 2011, titled POTABLE WATER CONTAINERS HAVING SURFACES INCLUDING HEAT LABILE COMPONENT/CARRIER COMBINATIONS AND METHODS FOR THEIR PREPARATION.

### BACKGROUND

The present invention relates to a container having a polymeric surface which includes a component/carrier combination or a plurality of component/carrier combinations, each component having a property expressed by the container's surface. At least one component is heat labile and/or individual components react or otherwise interfere with each other when combined, if not first absorbed on distinct carriers. The presence of the carrier can protect a heat labile component from decomposition or volatilization; and can make compatible, components that would otherwise be incompatible. Containers having a surface including a component/carrier combination can exhibit a range of new advantageous properties derived from the components. Containers can be formed from polymers, or other materials having a polymeric liner or coating. A Polymeric liner can be formed by extrusion and lamination processes, whereas a coating can be formed by the application of a surface treatment which can be transformed into a coating.

The inclusion of certain heat labile components into a polymer composition can offer important properties to a container's surface constructed from the resulting polymer composition. For example, if the heat labile component is a biocide, surfaces derived from a polymer/biocide compositions can be more resistant to biological degradation and provide surfaces that don't support the growth of a range of microorganisms and which can kill a range of microorganisms (including bacteria, fungi, algae, viruses, and the like) which contact the surface. Surfaces derived from such polymer/biocide compositions find particular uses in medical, transportation, education, athletics, workplaces, commercial field, and the like, where a need exists to create surfaces, equipment, and polymeric materials capable of resisting the colonization of microorganisms, killing microorganisms upon contact, and/or providing a barrier to microorganisms. Unlike topical applications of biocides which typically provide a concentration gradient across the applied surface leading to resistant strains, a surface derived from a polymer having a uniform distribution of a biocide therein, lacks a concentration gradient and at proper levels minimizes the formation of resistant strains. In addition, performance of this surface derived from the polymer/heat labile component/carrier combination is not dependent on whether a surface disinfectant was or was not applied according to established procedures. The ability to provide and maintain such substantially sterile surfaces and minimize the formation of resistant strains of microorganisms is particularly important in a host of container applications which are used for storing, moving or holding a range of items and materials, particularly for containers designed to hold potable water. The ability to maintain substantially sterile surfaces is particularly important in containers used with regard to materials consumed and contacted, such as for example, for containing potable water and other liquids, drinks, other fluids, foods, medicines, cosmetics, and the like. Containers can vary in size as illustrated by a lined soft drink can and a lined tank for city water.

The stability of the heat labile component can be important during manufacturing processes and the use of a container. Most polymers used to prepare a container or a material for its surface pass through a molten state at relatively high temperatures. Depending on the polymer, such processing temperatures typically range from about 180° C. to about 550° C. For a biocide to be successfully incorporated into such a polymer composition utilizing these standard methods, it must typically have sufficient thermal stability to survive any necessary processing at the elevated temperatures. Currently only a limited number of biocides have been successfully incorporated into polymers to provide polymers that exhibit some level of biocidal activity utilizing common manufacturing practices. Decomposition while processing a melt phase of the polymer biocide has typically inactivated the biocide included in the combination.

In addition, some containers and article surfaces experience elevated temperatures above the heat labile component's decomposition temperature, for longer and shorter periods of time in the course of the container's use. For example, a coffee cup having a heat labile component in its surface containing a freshly brewed cup of coffee can momentarily reach a temperature above a heat labile component's decomposition temperature, but well below the normal polymer processing temperatures. Additionally, in some instances, it would be beneficial for containers to include a plurality of components (including heat labile components) which are incompatible when directly mixed or combined. The ability to manufacture such advantageous containers utilizing standard methods and equipment would be particularly advantageous.

What is needed is a container having a surface exhibiting properties derived from a range of components such as for example, polymer/biocide compositions where the biocide is a heat labile component or is incompatible with another of the composition's components and which can be manufactured utilizing substantially standard manufacturing techniques. Further, methods are needed for producing containers having such surfaces. The current disclosure utilizing carrier technology addresses these needs.

### SUMMARY

In its broadest form, the present disclosure provides for a container having a polymeric surface exhibiting properties derived from one or more components included therein. The word “container” is meant to describe a container or something used for storing, moving, culturing, or holding contents; a receptacle. Containers typically have a least one opening, with or without a closure to introduce and/or remove contents. A container can, depending on its purpose, be large or small, and conform to any shape suited for its purpose. For example, both a tank and a pipe are understood to be containers. A container generally has an interior and an exterior surface, the interior surface defining a storing, moving, or holding region, for its contents. A container is intended to contain its contents until they are needed, utilized, or disposed of.

One aspect of the present disclosure provides for a container having a surface derived from a polymer including a heat labile component adsorbed on a carrier. The polymer has a melting temperature and the heat labile component has a decomposition temperature; wherein the polymer's melting temperature is greater than the heat labile component's decomposition temperature. The surface of the polymeric member can be formed from a molten mixture of the polymer and heat labile component adsorbed on a carrier particle under conditions which would result in decomposition or volatilization of the heat labile component without involvement of the carrier particle. The molten states typically occur at elevated temperatures. The addition of a heat labile component to a molten polymer without a carrier typically results in the components inactivation, decomposition, volatilization and the like, depending on the manner in which the component is heat labile. The component/carrier combination further protects a heat labile component from elevated temperatures during the container's service. Finally, containers derived from polymers including a plurality of component/carrier combinations can be constructed from polymers having at least one component that is incompatible with another component, or the polymer itself.

The container can be formed directly by molding, or subsequently constructed from extruded polymer components, depending on the nature of the container. Construction can involve the use of hot melt adhesives containing component/carrier combinations corresponding to those included in the polymer to provide a container surface exhibiting the same or similar properties.

A further aspect of the present disclosure provides for a method for preparing a container having a surface, wherein the surface includes a heat labile/carrier component. The method can involve the steps of: (a) providing a mixture including a polymer and a heat labile component adsorbed on a carrier, wherein the polymer has a melting temperature, the heat labile component has a decomposition temperature; (b) subjecting the mixture to a processing temperature for a time sufficient to form a melt containing the polymer and the heat labile component adsorbed on the carrier; and (c) cooling the melt to form the container's surface including the polymer and the heat labile component adsorbed on the carrier to form a container, where: (i) the processing temperature is greater than or equal to the melting temperature of the polymer; (ii) the processing temperature is greater than the heat labile component's decomposition temperature; and (iii) the heat labile component adsorbed on the carrier is distributed across the container's surface. This method can also be utilized to prepare polymeric components which can be further transformed into a container.

A further aspect of the method involves forming a container having a surface including a solid polymer having a surface and containing a plurality of incompatible components adsorbed onto separate carriers. The method involves the steps of (a) providing a molten phase of the polymer at a liquid processing temperature; (b) adding a plurality of incompatible components, each incompatible component adsorbed on a separate carrier, to the molten phase to provide a molten mixture; (c) subjecting the molten mixture to the processing temperature for a processing time sufficient to form a homogeneous molten phase containing the incompatible components; and (d) cooling the molten phase to form a container having a surface containing the incompatible components, distributed throughout, or to form a polymeric component from which a container can be constructed.

A still further aspect of the method involves incorporating a volatile component into a container's surface. The method involves the steps of (a) providing a molten polymer phase; (b) adding a volatile component adsorbed on a carrier to the molten polymer phase to provide a molten polymer mixture, wherein the volatile component has a boiling point and the molten phase has a liquid processing temperature, the boiling point being less than the processing temperature; (c) subjecting the molten mixture to a processing temperature for a processing time sufficient to form a homogeneous molten phase containing the volatile component adsorbed on the carrier without causing volatilization of the volatile component; and (d) cooling the molten phase to form a container having a surface including a volatile component, or to form a polymeric solid from which a container can be constructed.

A container can also be constructed to provide novel surface properties by preparing a container by any available material and method, and applying a surface treatment to the container's surface. Surface treatments can include paints, coatings, stains, varnishes, sealants, films, inks, and the like. For some applications, the use of component/carrier combinations protects the resulting container surface during application of the coating (as in the case of powder coatings and other thermoset coatings), whereas in other applications, protection is afforded the container after application, during the container's service. In still other applications, component/carrier combinations are used to incorporate an incompatible component into the surface coating. Component/carrier combinations can be included in the surface treatment formulation during its preparation or, alternatively, just before its application, and the surface treatment can be applied to the container by standard methods.

Finally, heat labile components can include materials having a wide range of properties ranging from biological activities (controlling the growth of microorganisms, plants, and insects), volatiles, such as fragrances, repellants, and materials which are inactivated by the exposure to elevated temperatures. Components utilized herein can include any component which is heat labile and can provide a desired property to the surface of a polymer processed at an elevated temperature, and/or any component which is incompatible with any other component of polymeric mixture to which it is being added and similarly provides a desired property to the surface of the polymer. The use of these components with carriers has protected the heat labile components and made compatible otherwise incompatible components.

In addition, other materials which are not heat labile will also likely benefit from the carrier technology provided. For example, the incorporation of materials such as plasticizers into carrier materials utilized in polymers may slow down the rate at which the plasticizer “blooms” to the plastic's surface, increasing its useful life. Similarly the incorporation of a component that adsorbs particular wavelengths of light into a clear plastic container can protect the article from light induced damage.

Containers can also be fitted with filtration components, such as for example anion and cation exchange resins, which can remove toxic anions and cations. Other filtration components, including activated carbon or adsorbent resins can remove organic impurities. Screens can be added to remove particulates. These components in conjunction with the biocidal polymers disclosed herein are effective in substantially upgrading water otherwise unsuitable for human or animal consumption.

### BRIEF DESCRIPTION OF THE DRAWINGS

FIG. 1 is a partial cross sectional view of a water container according to one example of the disclosed technology.

FIG. 2 is a partial cross sectional view of a water container according to another example of the disclosed technology.

FIG. 3 is a partial cross sectional view of a water container according to still another example of the disclosed technology.

FIG. 4 is a partial cross sectional view of a water container according to yet another example of the disclosed technology.

FIG. 5 is a partial cross sectional view of a water container according to another example of the disclosed technology.

FIG. 6 is a partial cross sectional view of another water container according to example of the disclosed technology.

FIG. 7 is a partial cross sectional view of still another water container according to another example of the disclosed technology.

FIG. 8 is a partial cross sectional view of yet another water container according to another example of the disclosed technology.

FIG. 9 is a partial cross sectional view of a water container according to another example of the disclosed technology.

FIG. 10 is a partial cross sectional view of a filter unit and storage tank according to one example of the disclosed technology.

FIG. 11 is a partial cross sectional view of a filter unit according to another example of the disclosed technology.

### DETAILED DESCRIPTION

For the purposes of promoting an understanding of what is claimed, references will now be made to the embodiments illustrated and specific language will be used to describe the same. It will nevertheless be understood that no limitation of scope of what is claimed is thereby intended, such alterations and further modifications and such further applications of the principles thereof as illustrated therein being contemplated as would normally occur to one skilled in the art to which the disclosure relates.

A container's contents can be damaged, destroyed, consumed, and contaminated in a variety of ways. A variety of microorganisms, macroorganisms, and the like can consume and/or degrade a container's contents and additionally enable secondary effects, such as disease, conditions, and the like, to be passed on to those who consume or otherwise handle and come in contact with the contents. The ability to protect a container's contents from attack by micro- and macroorganisms would avoid the content's loss and destruction and additionally prevent the contents from becoming a vehicle for the transmission of diseases, illnesses, and the like. In other cases, a container's contents can be damaged or destroyed by contact with light, temperature extremes and other environmental conditions.

In order to enable a container's surface to receive, maintain, culture, and discharge its contents in a condition that protects the content's quantity and quality as well as those who consume or otherwise handle them, a container's surface should express a variety of properties. The following examples are illustrative, and not intended to be restrictive in any manner. For example, a tank or pipe utilized to store or transport a fluid such as water or milk, for example, having an internal surface that kills and/or prevents the reproduction of bacteria, fungi, algae, viruses, and the like can maintain and even reduce the microorganism content of the fluid contained and/or transported therein. The inclusion of an appropriate enzyme can provide for the destruction of a variety of pesticides, nerve gas components and the like similarly contained in the fluid. A garbage can having a surface that includes animal and/or insect repellents can hold garbage for disposal without attracting animals and/or insects. The replacement of the animal repellent with an insecticide can cause the surface to exhibit insecticidal properties, rather than insect repellent properties. The internal surface of a tank utilized for the hydroponic growth of vegetables, can include one or more selective herbicides and algaecides to prevent unwanted vegetation that interferes with vegetable production. A container that includes both an insect pheromone and an insecticide can become a trap for the selective destruction of specific insects. A container for grain having a surface containing a rodenticide can destroy any rodents that attempt to gnaw into the container in search of food. A bee hive having internal surfaces that include a miticide can protect the bees therein from the Varroa mites, responsible for destroying many bee colonies. A clear plastic bottle having a surface containing a component that absorbs ultraviolet light can protect contents sensitive to the ultraviolet light.

Constructing containers with these properties utilizing standard methods has proven problematic. A majority of the components needed to impart the desired properties are heat labile and decompose or volatilize under conditions normally required to construct a container. During their use, containers, their liners, and/or coatings can become exposed to elevated temperatures causing decomposition of any heat labile components incorporated therein. When a component of within a container's surface decomposes, any properties associated with that component are no longer expressed. In other instances, the container experiences exposure to elevated temperatures during its service, that causes decomposition or volatilization. In addition, when a plurality of components (some of which can be heat labile components) is utilized to provide one or more properties, the necessary components often cannot be combined because one or more of the components are incompatible, that is they react, precipitate, or otherwise interfere with the formulations preparation. As a result, the formulation cannot exhibit the desired combination of properties.

Containers can be constructed entirely from polymers or in part from polymers by utilizing a polymer laminate, a film, or a coating derived from a surface treatment. For example, containers for bottled water can be prepared from polyesters; soft drink cans can be prepared from aluminum and lined with a polymer film or laminate (interior and/or exterior); tanks can be constructed from extruded sheets of polymer or coated with a thermoset resin. Extrusion, injection molding, the curing of a thermoset resin, and other methods for processing polymers require the formation of a melt at elevated temperatures substantially above a heat labile component's decomposition or volatilization temperature. Additionally, the ability to form a container having a surface that exhibits a combination of bacteriocidal, viruscidal, and/or fungicidal properties requires several components which, in addition to being heat labile, can be incompatible; reacting or precipitating when combined.

As noted above, surface treatments can include formulations in the form of paints, coatings, stains, varnishes, sealants, films, inks, and the like. The treatments can be formulated as aqueous, oil base or powder coatings and can be applied and cured, when necessary, according to procedures known in the art. Powder coatings are particularly useful for coating large containers, particularly large metal containers. Component/carrier combinations can be included during the preparation of the surface treatment or included in the formulation just prior to its application.

A variety of heat labile components and/or incompatible components can be incorporated into the surface of a variety of containers having a range of features, shapes, and uses. The surfaces can be external, internal, or a combination thereof. The container's surfaces can be formed in a number of ways known in the art and described herein. Each container or container surface can be created utilizing standard manufacturing equipment from a molten polymer, and its ability to exhibit properties derived from or related to the heat labile component that could not be achieved without the utilization of the heat labile component/carrier combination. The presence of the heat labile component/carrier combination and/or incompatible component/carrier combinations within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of container surfaces contemplated include, but are not limited to solid surfaces, mesh surfaces, porous surfaces, and the like. Container surfaces containing a heat labile component/carrier combination can remain sterile, kill microorganisms and the like upon contact, and prevent the spread of microorganisms though serial contact. Container surfaces containing a repellent, such as an animal and/or insect repellent, can maintain a region about the surface free of animals, insects and the like. A container's surface containing an insecticide can kill insects sensitive to the insecticide utilized that contact the surface. A container's surface containing a combination pheromone/insecticide can attract pheromone sensitive insects and upon contacting the surface kill insects sensitive to the insecticide utilized.

Polymers utilized to prepare containers typically have a melting temperature or a glass transition temperature (ranging from about 180° C. to about 550° C.) above which the polymer forms a viscous liquid to which a biocide/carrier combination can be added and mixed during processing. Such mixing provides for a generally uniform distribution of the various components within the mix and any subsequent container or surface derived from the mix. For some applications, it may be desirable to concentrate the components at or near the container's surface. Polymers utilized to form containers can include, but are not limited to organic polymers, inorganic polymers, copolymers including mixed organic/inorganic polymers, linear polymers, graft polymers, branched polymers, star polymers, and mixtures thereof. Depending on the biocide concentration, cooling and solidification of the resulting polymer/biocide composition can provide a product ranging from a concentrate (a “masterbatch”) for subsequent incorporation into additional polymer or to a finished container. Such masterbatch materials can be based on a single polymer or on a polymer blend.

Biocides may include, but are not limited to bacteriocides, fungicides, algaecides, miticides, viruscides, insecticides, herbicides rodenticides, animal and insect repellants, fragrances (including pheromones) and the like. In addition, biocides can also agents which are effective against protozoa, parasites, and other pathogens common to available water supplies. Many of the biocides suffer some level of decomposition, inactivation, and/or volatilization at the temperatures required to incorporate the biocide into the polymer/biocide composition, and/or which offer some advantage to the resulting polymer/biocide combination. In other words, the heat labile biocide is inactivated, decomposes or vaporizes upon exposure to the elevated temperatures and/or processing conditions if not adsorbed on a carrier. Biocides may also include biocides containing a quaternary amine group that accounts for some level of the compound's biocidal activity and contributes to the compound's heat labile nature. Because some heat labile components are not compatible when directly mixed, the loading of a single heat labile component onto a single carrier frequently provides improved results, and the use of a multiple of heat labile component/carrier combinations is possible.

Carriers are typically porous materials which remain solid at the processing temperature, having sufficient porosity to adsorb a sufficient amount of heat labile biocide. Carriers can be inorganic or organic, in nature. Porous silica particles illustrate an example of an inorganic porous carrier, and macroreticular cross-linked polystyrene resins illustrate an example of an organic carrier particle. Carriers are generally insoluble in the polymer's liquid phase at elevated temperatures, do not melt, or otherwise cease the function of a carrier during processing, and have a relatively high internal surface area. The heat labile component can be adsorbed on the carrier by contacting the carrier with a liquid form of the biocide. If the biocide is a liquid at a temperature below its decomposition temperature it can be used directly in its liquid form. If the biocide is a solid at the necessary processing temperatures, it can be dispersed or dissolved in a solvent, prior to adsorption onto the carrier. Any remaining solvent or dispersant can be removed or evaporated to provide a solid flowable carrier containing the biocide, for subsequent incorporation into a polymer or flashed off upon combination with the molten polymer. For example, solvents such as the lower boiling alcohols can be left on the carrier/biocide combination and volatilized upon contact with the molten polymer. For a carrier to be loaded with a dispersion of the heat labile component, the component's particle size should be smaller than the carrier's pores being entered.

Containers formed from a polymer/heat labile component/carrier combination; or a polymer/incompatible components/carriers combinations, formed at elevated temperatures provide advantages in a variety of ways. For example, container surfaces containing a combination of a bacteriocide, a viruscide, and a fungicide, can remain microorganism free reducing the opportunity for serial passage of disease causing microorganisms. Examples of such surfaces can be found in containers such as a cup, a bottle, a can liner, a tank, and a pipe, the lining of a water tower, a canteen, and the like. Finally, containers, such as a garbage receptacle, can be formed at elevated temperatures having a surface that includes an animal repellent, an insect repellent, an insecticide, a fragrance, an a range of additional biocides. A wide range of several different heat labile components and incompatible components can be made available at a container's surface to provide a range of properties.

The discovery of novel polymer compositions and methods for making the compositions has made it possible to construct a wide range of new containers exhibiting useful and novel properties. Because the novel polymer compositions can be processed with standard methods, a range of polymer derived products can be constructed from them according to standard methods. The following discussion teaches the new polymer compositions, and how to form them. Polymer derived products, including containers, can be constructed from the new polymers utilizing standard equipment according to known methods.

Broadly considered, the methods disclosed herein, generally involve subjecting one or more heat labile components to a processing step carried out at processing temperatures above the components' decomposition, volatilization, and/or inactivation temperature(s) without the components' decomposition, evaporation, and/or inactivation. Decomposition, evaporation, or inactivation is avoided by first adsorbing a heat labile component onto a carrier prior to processing and/or by limiting the processing time. Carriers typically are stable to the processing conditions, have the ability to load sufficient heat labile component, and/or have a generally low thermal conductivity. Based on work carried out at this time, carriers can have thermal conductivities lower than, higher than, or equal to the polymer phase within which the processing is being carried out. The method generally provides for combinations including one or more heat labile components that could not otherwise be processed without decomposition.

Heat labile components can additionally involve materials that are volatile at a polymer's processing temperature and unless incorporated into a carrier would vaporize, providing a surface without the volatile component. Incorporation of the volatile component into a carrier prior to incorporation into the polymer prevents substantial volatilization during processing. Volatile fragrances loaded into a carrier have been successfully incorporated into a range of polymers to provide polymer containers capable of emitting the fragrance over a long period of time. Additionally, volatile materials such as animal and insect repellants can be successfully loaded into polymers to provide combinations capable of repelling animals or insects for long periods of time.

In the discussion which follows, specific compositions and methods will be described with regard to one or more heat labile biocides. It is understood that other heat labile materials discussed herein can be utilized similarly to provide a variety of solids and surfaces from a molten phase which contain the other heat labile materials distributed throughout the solid. Solids and surfaces can be formed by molding, extrusion, coating, and other methods currently utilized in the industry.

The utilization of a combination of a component/carrier combination, including a heat sensitive component/carrier combination as a form for adding incompatible and heat sensitive components to molten polymers utilized to form containers or components of containers, can provide containers having surfaces which exhibit a range of properties derived from the combination of components. The discussion which follows is concerned with how surfaces utilized in containers can be produced to exhibit the properties of surface components which are heat labile and/or incompatible as well as the range of properties that can be introduced into an container's surface.

Polymers:

Based on testing carried out at this time, commonly used polymers have a glass transition temperature (or melting temperature) ranging from about 180° C. to about 550° C. At or above these temperatures the polymers form a viscous liquid to which a biocide/carrier combination can be added and mixed during initial processing. Such polymers include, but are not limited to organic polymers, inorganic polymers, mixtures of organic and inorganic polymers, copolymers including mixed organic/inorganic polymers, linear polymers, branched polymers, star polymers, and mixtures thereof. A specific polymer or polymer combination is typically selected to provide the necessary physical properties for an application at an acceptable cost.

Polymers generally suitable for processing according to the current disclosure include, but are not limited to:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), low density polyethylene (LDPE), linear low density polyethylene (LLDPE), branched low density polyethylene (BLDPE) and medium density polyethylene (MDPE). Polyolefins, i.e. the polymers of monoolefins exemplified in the preceding paragraph, preferably polyethylene and polypropylene, can be prepared by different, and especially by the following, methods:
a) radical polymerization (normally under high pressure and at elevated temperature).
b) catalytic polymerization using a catalyst that normally contains one or more than one metal of groups IVb, Vb, VIb or VIII of the Periodic Table.
   These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EM), LLDPE/EVA, LLDPE/EM and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/unsaturated ester, styrene/acrylonitrile, styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

7. Graft copolymers of styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, SAN, MBS, ASA or AES polymers.

8. Halogen-containing polymers such as polychloroprene, chlorinated rubbers, chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bis-glycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4, -trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides and polybenzimidazoles.

18. Polyesters derived from dicarboxylic acids and diols and/or from hydroxycarboxylic acids or the corresponding lactones, for example polyethylene terephthalate, polytrimethylene terephthalate, polybutylene terephthalate, poly-1,4-dimethylolcyclohexane terephthalate and polyhydroxybenzoates, as well as block copolyether esters derived from hydroxyl-terminated polyethers; and also polyesters modified with polycarbonates or MBS. Polyesters and polyester copolymers as defined in U.S. Pat. No. 5,807,932 (column 2, line 53), incorporated herein by reference.

19. Polycarbonates and polyester carbonates.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Drying and non-drying alkyd resins.

23. Unsaturated polyester resins derived from copolyesters of saturated and unsaturated dicarboxylic acids with or without halogen-containing modifications thereof of low flammability.

24. Crosslinkable acrylic resins derived from substituted acrylates, for example epoxy acrylates, urethane acrylates or polyester acrylates.

25. Alkyd resins, polyester resins and acrylate resins crosslinked with melamine resins, urea resins, polyisocyanates or epoxy resins.

26. Epoxy resins derived from polyepoxides, for example from bis glycidyl ethers or from cycloaliphatic diepoxides.

27. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

28. Blends of the aforementioned polymers (polyblends), for example PP/EPDM, Polyamide/-EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO.

29. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

30. Aqueous emulsions of natural or synthetic rubber, e.g. natural latex or latices of carboxylated styrene/butadiene copolymers.

31. Polysiloxanes such as the soft, hydrophilic polysiloxanes described, for example, in U.S. Pat. No. 4,259,467; and the hard polyorganosiloxanes described, for example, in U.S. Pat. No. 4,355,147.

32. Polyketimines in combination with unsaturated acrylic polyacetoacetate resins or with unsaturated acrylic resins. The unsaturated acrylic resins include the urethane acrylates, polyether acrylates, vinyl or acryl copolymers with pendant unsaturated groups and the acrylated melamines. The polyketimines are prepared from polyamines and ketones in the presence of an acid catalyst.

33. Radiation curable compositions containing ethylenically unsaturated monomers or oligomers and a polyunsaturated aliphatic oligomer.

34. Epoxymelamine resins such as light-stable epoxy resins crosslinked by an epoxy functional coetherified high solids melamine resin such as LSE-4103 (Monsanto).

Resins that do not have a glass transition temperature because of cross-linking or for other reasons can be incorporated by mixing with another polymer having a glass transition temperature within a necessary temperature range.

The following polymers are particularly suitable for this application: polyvinylchloride, thermoplastic elastomers, polyurethanes, high density polyethylene, low density polyethylene, silicone polymers, fluorinated polyvinylchloride, polystyrene, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. Depending on the biocide concentration, cooling and solidification of the resulting polymer/biocide composition can provide a product ranging from a concentrate (a “masterbatch”) for subsequent incorporation into additional polymer or a finished container.

Heat Labile Biocides:

Biocides utilized according to the present disclosure are generally biocides which have reduced stability when exposed to required processing conditions at temperatures above their decomposition temperature, although other biocides may also be used. A majority are biocides which have limited heat stability that prevent their incorporation into polymers by standard methods.

Biocides generally suitable for processing according to the current disclosure include, but are not limited to: Acetylcarnitine, Acetylcholine, Aclidinium bromide, Acriflavinium chloride, Agelasine, Aliquat 336, Ambenonium chloride, Ambutonium bromide, Aminosteroid, Anilinium chloride, Atracurium besilate, Benzalkonium chloride, Benzethonium chloride, Benzilone, Benzododecinium bromide, Benzoxonium chloride, Benzyltrimethylammonium fluoride, Benzyltrimethylammonium hydroxide, Bephenium hydroxynaphthoate, Berberine, Betaine, Bethanechol, Bevonium, Bibenzonium bromide, Bretylium, Bretylium for the treatment of ventricular fibrillation, Burgess reagent, Butylscopolamine, Butyrylcholine, Candocuronium iodide, Carbachol, Carbethopendecinium bromide, Carnitine, Cefluprenam, Cetrimonium, Cetrimonium bromide, Cetrimonium chloride, Cetylpyridinium chloride, Chelerythrine, Chlorisondamine, Choline, Choline chloride, Cimetropium bromide, Cisatracurium besilate, Citicoline, Clidinium bromide, Clofilium, Cocamidopropyl betaine, Cocamidopropyl hydroxysultaine, Complanine, Cyanine, Decamethonium, 3-Dehydrocarnitine, Demecarium bromide, Denatonium, Dequalinium, Didecyldimethylammonium chloride, Dimethyldioctadecylammonium chloride, Dimethylphenylpiperazinium, Dimethyltubocurarinium chloride, DiOC6, Diphemanil metilsulfate, Diphthamide, Diquat, Distigmine, Domiphen bromide, Doxacurium chloride, Echothiophate, Edelfosine, Edrophonium, Emepronium bromide, Ethidium bromide, Euflavine, Fenpiverinium, Fentonium, Gallamine triethiodide, Gantacurium chloride, Glycine betaine aldehyde, Glycopyrrolate, Guar hydroxypropyltrimonium chloride, Hemicholinium-3, Hexafluoronium bromide, Hexamethonium, Hexocyclium, Homatropine, Hydroxyethylpromethazine, Ipratropium bromide, Isometamidium chloride, Isopropamide, Jatrorrhizine, Laudexium metilsulfate, Lucigenin, Mepenzolate, Methacholine, Methantheline, Methiodide, Methscopolamine, Methylatropine, Methylscopolamine, Metocurine, Miltefosine, MPP+, Muscarine, Neurine, Obidoxime, Otilonium bromide, Oxapium iodide, Oxyphenonium bromide, Palmatine, Pancuronium bromide, Pararosaniline, Pentamine, Penthienate, Pentolinium, Perifosine, Phellodendrine, Phosphocholine, Pinaverium, Pipecuronium bromide, Pipenzolate, Poldine, Polyquaternium, Pralidoxime, Prifinium bromide, Propantheline bromide, Prospidium chloride, Pyridostigmine, Pyrvinium, Quaternium-15, Quinapyramine, Rapacuronium, Rhodamine B, Rocuronium bromide, Safranin, Sanguinarine, Stearalkonium chloride, Succinylmonocholine, Suxamethonium chloride, Tetra-n-butylammonium bromide, Tetra-n-butylammonium fluoride, Tetrabutylammonium hydroxide, Tetrabutylammonium tribromide, Tetraethylammonium, Tetraethylammonium bromide, Tetramethylammonium chloride, Tetramethylammonium hydroxide, Tetramethylammonium pentafluoroxenate, Tetraoctylammonium bromide, Tetrapropylammonium perruthenate, Thiazinamium metilsulfate, Thioflavin, Thonzonium bromide, Tibezonium iodide, Tiemonium iodide, Timepidium bromide, Trazium, Tridihexethyl, Triethylcholine, Trigonelline, Trimethyl ammonium compounds, Trimethylglycine, Trolamine salicylate, Trospium chloride, Tubocurarine chloride, Vecuronium bromide.

Preferred heat labile biocides include, but are not limited to, quaternary amines and antibiotics. Some specific preferred heat labile biocides include, but are not limited to, N,N-didecyl-N-methyl-N-(3-trimethoxysilylpropyl)ammonium chloride, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride.

Some specific antibiotics include, but are not limited to amoxicillin, campicillin, piperacillin, carbenicillin indanyl, methacillin cephalosporin cefaclor, streptomycin, tetracycline and the like. Preferred combinations of biocides generally include at least one heat labile biocide, which would not survive incorporation into a specific polymer unless adsorbed onto a carrier. Examples of preferred fungicides include iodopropynylbutylcarbamate; N-[(trichloromethyl)thio]phthalimide; and chlorothalonil. Examples of preferred bactericides include benzisothiazolinone and 5-chloro-2-methyl-4-isothiazolin-3-one. Other biocides which can be utilized according to this disclosure include, but are not limited to, bactericides, fungicides, algicides, miticides, viruscides, insecticides, herbicides rodenticides, animal and insect repellants, and the like. Fragrances and other volatile heat labile components can similarly be incorporated into the various polymers at elevated temperatures.

The Carriers:

Carriers are typically porous materials capable of adsorbing the heat labile biocide, remaining in a solid form during processing, and maintaining the biocide in the adsorbed state during processing. Carriers having a substantial porosity and a high surface area (mostly internal) are used in some embodiments of the present invention. Optionally, a carrier which has a relatively low thermal conductivity is used. Finally, for some applications, carriers which do not alter the color or appearance of the polymer may be used.

Inorganic Carriers:

As a class, platy minerals generally perform well as carrier materials. Minerals which may be used as carriers include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Based on testing thus far, silica (silicon dioxide) has yielded promising results. Generally, carriers having lower thermal conductivities are capable of performing at higher temperatures and for longer processing times. Based on work carried out at this time, carriers having a thermal conductivity as high as 21 W/m·K can be utilized in some polymer/biocide combinations, although carriers having higher thermal conductivities may also be used. Mixtures of carriers can also be utilized.

Organic Carriers:

A class of carriers that have proven particularly suitable includes polymeric carriers. Polymeric carriers typically remain solid at elevated temperatures and are capable of loading sufficient quantities of biocide. Polymeric carriers may include organic polymeric carriers such as cross-linked macroreticular and gel resins, and combinations thereof such as the so-called “plum pudding” polymers. Other organic polymeric carriers include macroreticular resins, some of which can include other resins within the polymer's structure. Resins for imbedding within a macroreticular resin include other macroreticular resins or gel resins. Additionally, other porous non-polymeric materials such as minerals can similarly be incorporated within the macroreticular resin.

Organic polymeric carriers can include polymers lacking a functional group, such as a polystyrene resin, or the suitable organic polymeric carrier can have a functional group such as a sulfonic acid included. Generally, any added functional group should not substantially reduce the organic polymeric carrier's thermal stability. An organic polymeric carrier is typically able to load a sufficient amount of biocide, survive any processing conditions, and deliver an effective amount of the biocide upon incorporation into any subsequent system. Organic polymeric carriers can be derived from a single monomer or a combination of monomers.

General methods for making macroreticular and gel polymers are well known in the art utilizing a variety of monomers and monomer combinations. Monomers for the preparation of organic polymeric carriers include, but are not limited to styrene, vinyl pyridines, ethylvinylbenzenes, vinyltoluenes, vinyl imidazoles, an ethylenically unsaturated monomers, such as, for example, acrylic ester monomers including methyl acrylate, ethyl acrylate, butyl acrylate, 2-ethylhexyl acrylate, decyl acrylate, methyl methacrylate, butyl methacrylate, lauryl(meth)acrylate, isobornyl(meth)acrylate, isodecyl(meth)acrylate, oleyl(meth)acrylate, palmityl(meth)acrylate, stearyl(meth)acrylate, hydroxyethyl(meth)acrylate, and hydroxypropyl(meth)acrylate; acrylamide or substituted acryl amides; styrene or substituted styrenes; butadiene; ethylene; vinyl acetate or other vinyl esters such as vinyl acetate, vinyl propionate, vinyl butyrate and vinyl laurate; vinyl ketones, including vinyl methyl ketone, vinyl ethyl ketone, vinyl isopropyl ketone, and methyl isopropenyl ketone; vinyl ethers, including vinyl methyl ether, vinyl ethyl ether, vinyl propyl ether, and vinyl isobutyl ether; vinyl monomers, such as, for example, vinyl chloride, vinylidene chloride, N-vinyl pyrrolidone; amino monomers, such as, for example, N,N′-dimethylamino(meth)acrylate; and acrylonitrile or methacrylonitrile; and the monomethacrylates of dialkylene glycols and polyalkylene glycols. Descriptions for making porous and macroreticular polymers can be found in U.S. Pat. No. 7,422,879 (Gebhard et al.) and U.S. Pat. No. 7,098,252 (Jiang et al.).

The organic polymeric carriers can contain other organic polymeric particles and/or other inorganic carrier particles, such as minerals typically characterized as platy materials. Minerals incorporated into a polymeric carrier include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Mixtures of different carriers can also be utilized.

Selection of Components:

The choice of polymer(s) is generally made to provide a container having necessary and desired properties and a cost consistent with its use. Carriers are typically selected based on their porosity, surface area, and thermal conductivity. Based on the current studies, a maximum thermal conductivity has not been established. Porosity and surface area determine how much biocide can be loaded onto the carrier and generally reduces the amount of carrier required. The thermal conductivity is believed to contribute to how much above the biocide's decomposition temperature the polymer can be processed and how long the processing step can take. For example, a carrier having a high thermal conductivity may be useful in processing a polymer biocide combination where the polymer's melt temperature is only slightly above the biocide's decomposition temperature and/or the processing time is relatively short. For processing temperatures well above the biocide's decomposition temperature or for processing for longer times, a carrier having a lower thermal conductivity will generally be more satisfactory. The selection of biocide primarily depends on the use of the polymer/biocide combination. For example, the biocide loading can be tailored to target specific microorganisms or specific combinations of microorganisms, depending on the end use. Combinations of biocides can be utilized including both heat stabile and heat labile biocides in order to fulfill specific needs. In addition, combinations of biocides including bactericides, viruscides, fungicides, insecticides, herbicides, miticides, rodenticides, animal and insect repellants, and the like can be incorporated into a single polymer, depending on it end use.

The Process:

The carrier/biocide combination has been produced by contacting a carrier with a liquid form of the biocide (typically a solution or a suspension), allowing adsorption onto the carrier to occur and evaporating any solvent to provide the carrier/biocide combination in the form of a flow-able powder. Carrier loaded biocides containing as much as 60% biocide have been prepared.

For some methods, a processing temperature is established for the polymer/biocide combination and a maximum processing time at the processing temperature is established, before the processing is carried out. Processing equipment is selected to minimize melt time for the polymer/carrier/biocide combination. Conventional equipment for processing polymers can generally be used. Based on current work, single or twin thermal screws are effective for producing both masterbatch material and finished containers. Standard pellet extrusion has proven a useful method for producing masterbatch materials. Finished containers or intermediate forms of the polymer can be prepared by the following techniques: injection molding, roll molding, rotational molding, extrusion, casting, and the like. Other manufacturing methods and techniques known in the art may also be used. Carrier/biocide loading into the polymer melt can run as high as about 40 wt. % carrier/biocide. For masterbatch materials, the carrier/biocide concentration typically runs as high as about 40 wt. %. For finished containers or intermediate forms, biocide levels in the range of about 0.25 wt. % to about 10 wt. % have proven effective against microorganism's tested. However, even higher loadings are contemplated and will be effective.

Applications Utilizing Biocidal Polymers:

Applications involving the polymer/biocide combination taught herein include, but are not limited to, a wide range of containers utilized in the medical, municipal, educational, and consumer fields including hospital, consumer products, food packaging, and the like. Any container that is or could be prepared from a polymer melt or surface treatment that otherwise requires processing at an elevated temperature and which would benefit from the ability to limit the growth of microorganisms can be improved by utilizing the polymer/biocide combinations taught herein. The examples which follow relate to the incorporation of biocides/carrier combinations are illustrative of how other component/carrier combinations can be utilized to provide new surface properties to a container. Some specific examples of containers which can benefit by the incorporation of components/carrier combinations according to the methods taught herein, into the container's surface include, but are not limited to tanks and pipes used for processing, storing, and transporting potable water; containers used in food processing and distribution; and containers for drinks, medicines, pharmaceutical products, medical supplies, light sensitive products, and the like. Containers, such as garbage cans can be prepared utilizing the component/carrier technology taught herein that repel animals and insects, and prevent the growth of disease producing microorganisms, and emanate a fragrance to mask any odors related to the garbage contained therein. This is particularly desirable for garbage cans/bags awaiting pickup in unattended locations. Containers manufactured from polymeric materials containing component/carrier combinations can ultimately be recycled without leaching substantial amounts of biocides/pesticides into the environment.

Containers for Potable Water

In the following discussion of particular examples of water containers according to the disclosed technology, many of the example containers are shown as flask-type bottles. This particular style of container is shown for illustrative purposes only. It should be understood by one of ordinary skill in the art that the disclosed technology could also be applied to other container designs or styles as desired. Some other container types include bottles, milk jugs, canteens, bota or wineskin bags, hydration packs, and the like. Larger containers may also be used such as barrels, drums, or large tanks such as those found on trucks or railcars where large quantities of potable water are desired such as in areas which lack reliable sources of safe drinking water or in areas which have temporarily lost their potable water supply (such as after natural disasters).

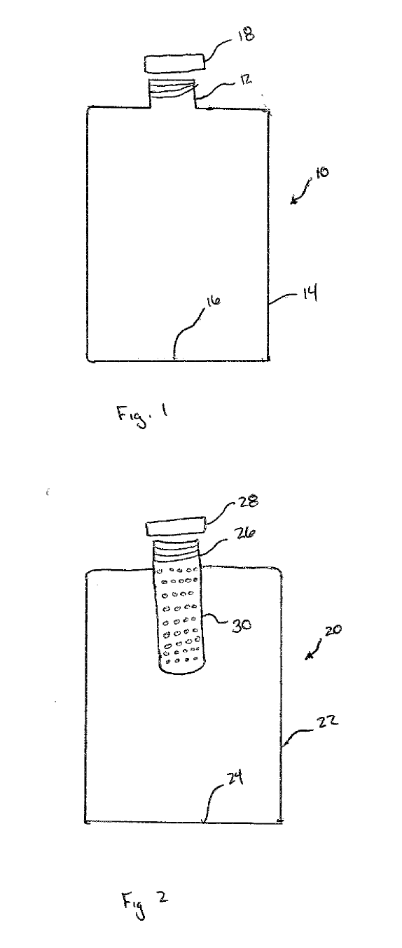

FIG. 1 shows a partial cross sectional view of a water container for potable water or another liquid according to one example of the disclosed technology. In this particular example, a container 10 is comprised of an outer surface 14, an inner surface 16, and includes an opening 12 through which liquids may pass and which may be closed using a closure 18. In this particular example, opening 12 is shown as a straight-sided neck having a threaded outer surface compatible with a complimentary threaded inner surface (not shown) on closure 18 which as shown as a cap. In other examples, closure 18 is securable to opening 12 using internal rather than external threads, or using a means other than threads such as corks, stoppers, cam-lever closures, spring type closures, lightning-type closures, bayonet-style closures, or any other suitable closure method. In some other examples, the opening may lack a closure method entirely, such as in applications where rainwater is to be collected in the container. Opening 12 may be a spigot, nipple, hose, fill tube, or other suitable passage through which liquid may pass. Opening 12 may be larger or smaller relative to the size of container 10 than shown as desired. Optionally, container 10 may also include a handle, strap, clip, connector, or other suitable means for carrying or securing the container.

Continuing with the example shown in FIG. 1, container 10 is made from a polymer having one or more heat labile component(s) using one of the methods described herein. Any heat liable component may be used as desired, such as those having bactericidal activity, fungicidal activity, viruscidal activity, insecticidal activity, miticidal activity, and/or algicidal properties or any combination thereof. Water is then added to container 10 through opening 12 and stored therein for a period of time to allow contact between the water and interior surface 16 thereby allowing the heat liable component in the polymer to act on contaminants in the water. The amount of time necessary to neutralize or otherwise reduce the activity of the contaminants in the water will vary according to a number of factors including temperature, the nature and/or concentration of the contaminant, the nature and/or concentration of the heat liable component, the interior surface area of the container, mixing/agitation of the container, as well as possible other factors. When enough time has passed to reduce/eliminate activity of the contaminant(s), the water may be decanted through opening 12 and consumed.

In other examples, container 10 may be made of a material other than a polymer (such as metal, glass, leather, etc.) and interior surface 16 may be a layer of a polymer having one or more heat labile component(s) using one of the methods described herein applied to the interior surface of the container. In still other examples, water or another liquid may be potable and/or contain no or sufficiently low levels of contaminants before being added to container 10. Rather than purify/reduce contamination in a liquid, container 10 may be made from a polymer containing one or more heat labile components with the goal of preventing the growth of undesirable organisms in a potable liquid being stored in container 10. For example, container 10 may made from a polymer having a heat-liable bactericide to inhibit bacterial growth in water or another liquid during storage.

FIG. 2 shows a partial cross sectional view of a water container for potable water according to one example of the disclosed technology. In this particular example, a container 20 is made from a polymer having one or more heat labile component and is comprised of an outer surface 22, an inner surface 23, and includes an opening 26 through which liquids may pass and which may be closed using a closure 28. Liquid passing through opening 26 must also pass through a filter element 30. Filter 30 may be removable or part of container 20. Different compositions, structures, and functionalities of filter 30 may be used as desired. For example, filter 30 may comprise a simple mesh screen designed to filter out particulate matter. In other examples, filter 30 may comprise an activated charcoal cartridge as is known in the art. In still other examples, filter 30 may include permeable or semi-permeable membranes either alone or in combination with activated charcoal or other filtering components. Optionally, filter 30 may be made of and/or contain a polymer having one or more heat labile component(s) using one of the methods described herein. Operation of the container 20 shown in FIG. 2 is similar to that of the container shown in FIG. 1.

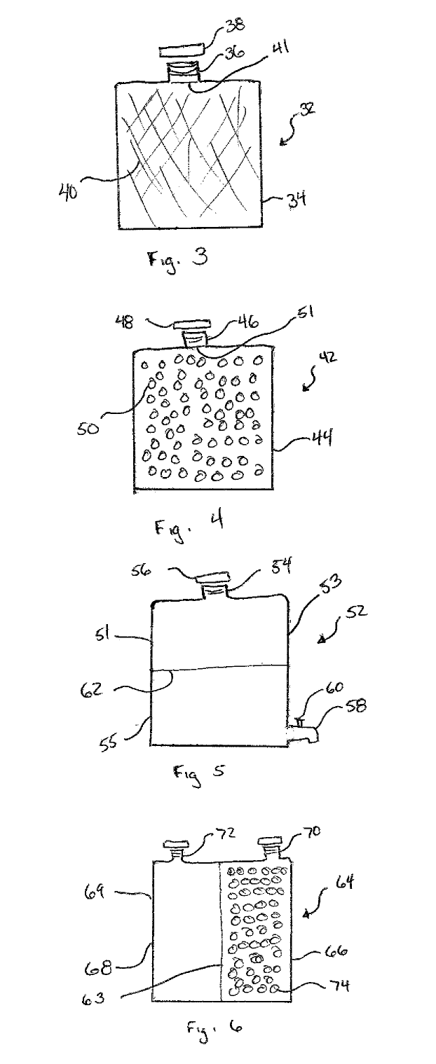

FIG. 3 shows a partial cross sectional view of a water container for potable water according to one example of the disclosed technology. In this particular example, a container 32 is made from a polymer having one or more heat labile component. Optionally, container 32 may be made from a material other than a polymer such as metal, wood, leather, glass, and the like. Container 32 is comprised of an interior space 34 having an opening 36 through which liquids may pass and which may be closed using a closure 38. Interior space 34 contains a plurality of filaments or fibers 40 made from a polymer having one or more heat labile component(s) using one of the methods described herein. Optionally, a membrane or screen partially or completely covers opening 36 to prevent fibers 40 from accidentally being removed while decanting liquids from the container. Operation of container 32 is substantially similar to that of container 10 shown in FIG. 1. In this particular example, the surface area of the filaments 40 is substantially greater than the surface area of inner surface 16 which increases water to surface contact and decreases the latency time between when contaminated water is added to container 32 and when potable water may be decanted and used. The size, number, composition, and structure of the fibers/filaments may vary as desired. Optionally, fibers/filaments made from polymers having different heat labile components may be used in a single container. For example, a container made include some fibers having a heat labile bactericide and other fibers containing a heat labile viruscide.

FIG. 4 shows a partial cross sectional view of a water container for potable water according to one example of the disclosed technology. In this particular example, a container 42 is made from a polymer having one or more heat labile component. Optionally, container 42 may be made from a material other than a polymer such as metal, wood, leather, glass, and the like. Container 42 is comprised of an interior space 44 having an opening 46 through which liquids may pass and which may be closed using a closure 48. Interior space 34 contains a plurality of matrix objects 50 made from a polymer having one or more heat labile component(s) using one of the methods described herein. The matrix objects 50 in this particular example are shown as spheres, but matrix objects of other types or styles such as rings, rods, beads, spheroids, pellets, and the like may also be used. Optionally, a membrane or screen partially or completely covers opening 46 to prevent matrix objects 50 from accidentally being removed while decanting liquids from the container.

Operation of container 42 is substantially similar to that of container 10 shown in FIG. 1. In this particular example, the combined surface area of the matrix objects 50 is substantially greater than the surface area of inner surface 16 which increases water to surface contact and decreases the latency time between when contaminated water is added to container 42 and when potable water may be decanted and used. Optionally, matrix objects made from polymers having different heat labile components may be used in a single container. For example, a container made include some matrix objects having a heat labile bactericide and other matrix objects containing a heat labile viruscide. In still other examples, matrix objects having different structures (for example, rings and beads) may be used in a single container.

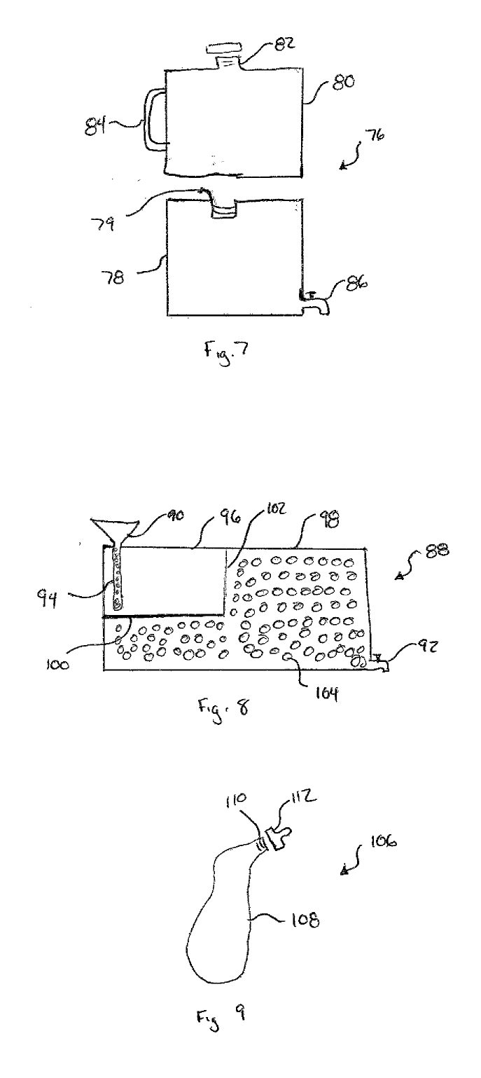

FIG. 5 shows a partial cross sectional view of a water container for potable water according to one example of the disclosed technology. In this particular example, a container 52 is made from a polymer having one or more heat labile component. Optionally, container 52 may be made from a material other than a polymer such as metal, wood, leather, glass, and the like. Container 52 is comprised of an interior space 51 having an opening 54 through which liquids may pass and which may be closed using a closure 56. Interior space 51 is divided into two portions 53 and 55 separated by a permeable barrier or membrane 62. Water added to container 52 through opening 54 goes into portion 53 and must pass through barrier 62 before entering portion 55. Container 52 further includes a second opening 58 from which water or other liquids may be decanted from portion 55. Opening 58 is shown as a spigot having a knob 60 to control water flow, but other suitable openings (straight sided necks, nozzles, tubes, hoses, nipples, etc.) and/or other means for controlling flow (valves, stoppers, diaphragms, etc.) may also be used.

During operation, contaminated water is added to interior portion 53 through opening 54. Contaminated water must pass through barrier 62 before entering interior portion 55. Barrier 62 is made from a polymer having one or more heat labile component using one of the methods described herein. Optionally, barrier 62 is comprised of a plurality of membranes or barriers which are each made from a polymer having one or more heat labile component. For example, barrier 62 may be made from a first layer made form a polymer having a heat labile bactericide, a second layer made form a polymer having a heat labile viruscide, and a third layer made form a polymer having a heat labile fungicide. Potable water is then decanted from interior portion 55 through opening 58.

FIG. 6 shows a partial cross sectional view of a water container for potable water according to one example of the disclosed technology. In this particular example, a container 64 is made from a polymer having one or more heat labile component. Optionally, container 64 may be made from a material other than a polymer such as metal, wood, leather, glass, and the like. Container 64 is comprised of an interior space 69 having an opening 72 through which liquids may pass and which may be closed using a closure. Interior space 69 is divided into two portions 66 and 68 separated by a permeable barrier or membrane 63. Water added to container 64 through opening 72 goes into portion 68 and must pass through barrier 63 before entering portion 66. Container 64 further includes a second opening 70 from which water or other liquids may be decanted from portion 66. Interior portion 66 further includes a plurality of matrix objects 74 similar to those previously described with respect to FIG. 4. In another example, interior portion 66 may include fiber elements similar to those described with respect to FIG. 3 instead of matrix objects. In still another example, interior portion 68 may also include fiber elements and/or matrix objects.

Operation of container 64 is similar to that described for container 52 shown in FIG. 5. Contaminated water is added to interior portion 68 through opening 72. Contaminated water must pass through barrier 63 before entering interior portion 66. Barrier 63 is optionally made from a polymer having one or more heat labile component using one of the methods described herein. Optionally, barrier 63 is comprised of a plurality of membranes or barriers which are each made from a polymer having one or more heat labile component. Optionally, matrix objects 74 made from polymers having different heat labile components may be used in a single container. For example, a container made include some matrix objects having a heat labile bactericide and other matrix objects containing a heat labile viruscide. In still other examples, matrix objects having different structures (for example, rings and beads) may be used in a single container. Potable water is then decanted from interior portion 66 through opening 70.

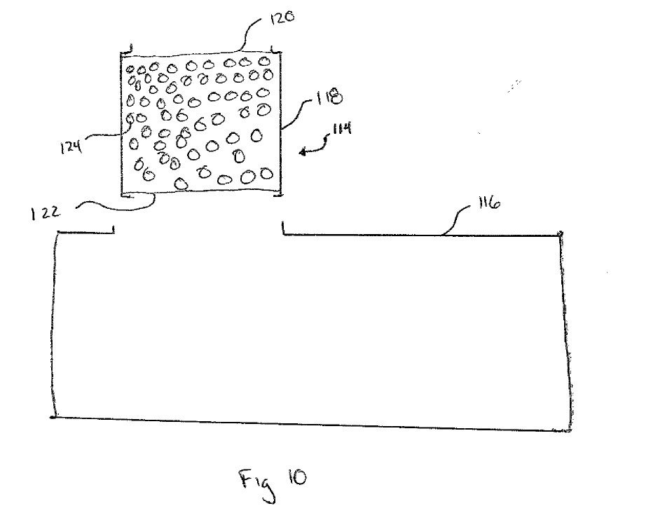

FIG. 7 shows a partial cross sectional view of a water container for potable water according to one example of the disclosed technology. In this particular example, a container 76 is comprised of two separable portions herein referred to as a fill portion 80 and a decant portion 78 for purposes of convenience. Fill portion 80 includes a fill opening 82 which may optionally be closed using a cap or stopper, and an optional handle for easy of carrying and transporting the fill portion 80. Decant portion 78 includes an opening 86 for decanting potable liquid from the decant portion (shown here as a spigot although other means for controlling flow through the opening may also be used as previously discussed). Decant portion 78 also includes a fill opening 79 sized and configured to accommodate opening 82 on fill portion 80. In this particular example, opening 79 and opening 82 are shown as a threaded connection so that the two portions 78 and 80 may be securely connected. Optionally, other methods of securably connecting portion 78 to portion 80 may also be used. Optionally, portion 80 may simply be held on portion 78 by the operation of gravity when opening 79 and opening 82 are operationally connected.

During operation, contaminated water is added to fill portion 80 through opening 82. Because fill portion 80 is separable from decant portion 78, fill portion 80 may be submerged or otherwise contact the contaminated water source (such as a river, stream, lake, or other body of water) without the risk of contaminating decant portion 78. Additionally, if the source of water is located at a distance from where the water will be used (such as a camp site that is not located near a water source), then only a portion 80 of the entire container 76 has to be carried to and from the water source. When filled with contaminated water, fill portion 80 is inverted from the position shown in FIG. 7 and opening 82 is operably connected to opening 79. Water then flows from portion 80 into portion 78, from which potable water may be decanted through opening 86.

In this particular example, a container 76 is made from a polymer having one or more heat labile component. Optionally, container 76 may be made from a material other than a polymer such as metal, wood, leather, glass, and the like. Additionally, portion 80 and/or portion 78 may include one or more of the fibers (FIG. 3), matrix objects (FIG. 4), and/or barriers (FIG. 5) made from a polymer having one or more heat labile components as previously described.

Potable water containers may also be made for producing large volumes of water using the technology disclosed herein. Containers can be sized according to the volume of potable water desired. Smaller, one gallon containers are typically suitable for personal use. Larger sizes such as fifty-five gallon drums, large tanks transported by trucks holding hundreds to thousands of gallons, or even tanks used as rolling stock on railroads holding tens of thousands of gallons may be used where large volumes of potable water are required. FIG. 8 shows a container 88 having a fill opening 90 and a decant opening 92. The interior of container 88 is divided into two portions 96 and 98 separated by an impermeable barrier 100 and a permeable barrier 102. Interior portion 98 is shown containing matrix objects 104 such as those previously described with respect to FIG. 4. Interior portion 96 includes a filter element 94 similar to that described with respect to FIG. 2.

In this particular example, fill opening 90 is shown as a funnel which may be suitable in situations where large volumes of water must be added to the container using buckets. Contaminated water added through fill opening 90 passes through filter element 94 and into interior portion 96. The water then passes through barrier 102 and enters interior portion 98, from which it may be decanted via opening 92. Some or all of the components of container 88, including the walls of the container, impermeable barrier 100, permeable barrier 102, filter element 94, and matrix objects 104 may be formed from a polymer having one or more heat labile components as previously described selected so as to eliminate, neutralize, or otherwise reduce the number or concentration of one or more undesired elements found in the water such as bacteria, viruses, microbial cysts, protozoa, algae, fungi, and/or any other compound or organism which may make water unsuitable for human consumption.

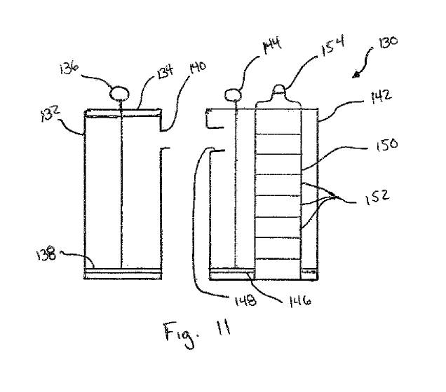

A smaller, bota-style water skin is shown in FIG. 9. In this particular example, a soft-sided water skin 106 having a container portion 108 having an opening 110 and a stopper 112 for closing said opening is shown. Such soft-sided water containers may also be known as bota bags, wineskins, hydration packs, and are typically sized for personal use (although large water bags holding hundreds of gallons are used by the military for storing water at remote bases). Such containers are traditionally made of leather, hide, intestines, or some other portion of an animal, but modern versions are typically made of rubber or a flexible polymer. In this particular example, the container portion 108 may be made from a polymer having one or more heat labile components as previously described selected so as to eliminate, neutralize, or otherwise reduce the number or concentration of one or more undesired elements found in the water such as bacteria, viruses, microbial cysts, protozoa, algae, fungi, and/or any other compound or organism which may make water unsuitable for human consumption. Stopper 112 is separable from container portion 108 so that the container may be filled from a contaminated source of water without risking contamination of the stopper. Optionally, stopper 112 includes a closable nipple potion or nozzle to allow consumption of the water directly from the container. Container 106 may also include a handle, strap, clasp, or other device for carrying the container or attaching it to another object such as a belt or backpack. Optionally, container 106 also contains fibers (FIG. 3), matrix objects (FIG. 4), or membranes (FIG. 5) also formed from polymers having one or more heat labile components as previously described.

In another example of the disclosed technology, a filter unit 114 is removably mounted to an existing water storage tank 116, such as that shown in FIG. 10. In this particular example, the filter unit is comprised of a chamber 118 having a first opening 120, and a second opening 122. Matrix objects 124 such as those described with respect to FIG. 4 fill chamber 118 and are kept in place using screens, membranes, or other suitable barriers across openings 120 and 122 which will allow the passage of water but will prevent the passage of matrix objects 124 therethrough. Optionally, filter unit 114 may include additional chambers as desired or additional filter units may be used either in series or in parallel. The matrix objects 124 shown in this particular example may be replaced with or used in conjunction with fibers such as described in FIG. 3 and/or membranes such as described in FIG. 5. Contaminated water is poured into opening 120, passes through chamber 118, and passes through opening 122 into tank 116. Filter units such as the one shown in FIG. 10 may be useful in situations where existing water treatment capabilities are disabled (such as by a power outage) or are overwhelmed (such as by heavy rainfall). The filter unit can be easily removed from the existing tank once previous water purification capacity has returned to normal.

FIG. 11 shows a filter and container combination according to another example of the disclosed technology. In this particular example, a container 130 is comprised of a collection unit 132 and a filtering unit 142. The collection unit 132 may be removably mounted to the filtering unit 142 using a quick connect type attachment system 140, 148 or any other connection method that is hydraulically sealable as is known in the art. Optionally, the collection unit has a handle, attachment point for a rope or cord, or other means of lowering the collection unit into a water source for collection so the user does not have to directly contact a potentially contaminated water source or be able to reach a water source by hand. In this particular example, the top of the collection unit 132 is removable so that water may be collected through the top of the unit by lowering it into a water source. In other examples, the collection unit has a separate, sealable opening through which water may be collected quickly so as to minimize the amount of time a user has to spend at or near the water source.

The full collection unit 132 is then operably connected to the filtering unit 142 using the connection points 140, 148. Because the collection unit 132 and the filtering unit 142 are separable, only the filtering unit has been in contact with the potentially contaminated water source. Once connected, a plunger 138 is pulled up using a handle or ring 136, thereby forcing the contaminated water from the collection unit 132 into the filtering unit 142. One or both connection points 140, and/or 148 can be fitted with a replaceable filter (not shown) to remove particulates and/or macroscopic microorganisms. The action of the plunger also agitates the water thereby increasing contact between the water and the sides of the collection unit 132 and the filtering unit 142, both of which may be made from polymer materials incorporating one or more heat labile materials as previously described. Once the water has been transferred to the filtering unit 142, the collection unit 132 may be disconnected and refilled, or simply left attached to the filtering unit 142 as desired.

The filtering unit 142 includes a filtering column 150, and a plunger 146 activated by a ring or knob 144. The filtering column 150 is comprised of a plurality of layers 152, the exact number and composition of which may vary from application to application. Individual layers are comprised of beads, resin, pellets, rings, fibers, or some other suitable material made from polymers containing one or more heat labile materials as previously described and designed so as to allow water to flow therethrough while promoting contact and interaction between the water and the material. The exact nature of the heat labile material may vary as desired, but some materials may include bactericides, fungicides, algaecides, viruscides, miticides, or any combination thereof. Individual layers may be comprised of different materials, the same materials, or different materials having the same desired functionality (e.g., two layers that contain different materials that both have anti-bacterial properties). Optionally, layers may comprise non-polymeric materials and/or polymeric materials that do not contain heat labile components such as the kind described herein. For example, a layer may comprise activated charcoal, or a screen designed to trap grit or other debris. Optionally, the filter column 150 is removable from the filtering unit 142 so it may be replaced as needed.

Water is forced through the filter column 150 by depressing the plunger knob 144, thereby moving the plunger 146 down and forcing water up into the column. Water is filtered and/or purified by interaction with the layers 152 of the column 150 and is forced out through an opening 154 at one end of the column 150. In this particular example, the opening 154 is shown as a resealable drinking nipple, although other types of closures such as caps, nozzles, spigots, and the like may also be used. Optionally, the opening may be hydraulically connected to a tube or line that allows the potable water to empty into a separate storage and/or drinking container. In another example, a separable collection unit is operationally connected to the filtering unit using a means similar to that which connected the collection unit 132 to the filtering unit 142 as previously described.

### SPECIFIC EXAMPLES

### Example 1

### Preparation of Silica Loaded with N,N-Didecyl-N-Methyl-N-(3-Trimethoxysilylpropyl)Ammonium Chloride

83 parts by weight of a methanolic solution containing 72% N,N-didecyl-N-methyl-N-(3-trimethoxysilylpropyl)ammonium chloride was combined with 40 parts by weight of fumed silica (SiO₂). The moist combination was mixed for about 5 minutes at ambient temperature in a high speed mixer at approximately 1200 rpm to provide a flowable powder. More dilute solutions of the biocide produces a wet paste, rather than a flowable powder. The resulting methanol wet carrier/quaternary salt can be incorporated into a polymer directly or dried before further use.

This method was used to prepare carrier/biocide combinations utilizing silica and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride. Additionally, the method described above can also be utilized to prepare other carrier/biocide combinations utilizing the carriers including clay; kaolin; perlite bentonite; talc; mica; calcium carbonate; titanium dioxide; zinc oxide; and iron oxide.

### Example 2

### Preparation of Carrier/Polymer Masterbatch Pellets

A heated single thermal screw equipped with a port for addition of the carrier and a port for removal of methanol vapor was prepared for the thermal extrusion of polystyrene. Once molten polystyrene was moving through the extruder, the carrier/quat combination prepared above was added to the extruder at a rate to provide a polymer:carrier/biocide ratio of 60:40, by weight. Methanol and other volatiles were vented from the venting port. The extruder was operated to provide a polymer residence time within the extruder of about 1-2 minutes. The hot polymer was extruded into water to produce a pencil shaped extrusion product that was subsequently cut into pellets. The resulting wet pellets were separated from the water, dried, and sized for subsequent incorporation into polymer containers. Similar masterbatch pellets were prepared according to this procedure incorporating the carrier/biocide combinations including silica and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, or N-didecyl-N-dimethyl-ammonium chloride.

This procedure was also used to prepare similar masterbatch pellets utilizing polyvinylchloride, thermoplastic elastomers, polyurethanes, high density polyethylene, low density polyethylene, silicone polymers, fluorinated polyvinylchloride, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. Masterbatch pellets can similarly be made using a combination or blend of polymers.

For polymers that have high melt viscosities, a thermal screw extruder having good mixing is important in order to ensure the complete distribution of the carrier/biocide throughout the entire melt.

### Example 3

### Preparation of Containers from Masterbatch Pellets

A single screw heated extruder of the type described above for preparing the master batch material was used to extrude a sheet form of the polymer. As in the method for preparing a master batch material, polystyrene was introduced into the extruder to provide a melt by the time material reached the addition port. The master batch material prepared above was added through the addition port to provide a ratio of biocide/polymer of about 0.25 wt. % to 10 wt. %. Residence time within the extruder was controlled between 1 and 2 minutes to provide polystyrene in a sheet form. Using the same equipment, and masterbatch pellets incorporating the other polymers listed or blends thereof, this procedure was used to prepare sheet forms of polyvinylchloride, thermoplastic elastomers, polyurethanes, high density polyethylene, low density polyethylene, silicone polymers, fluorinated polyvinylchloride, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. All of the polymers came through the processing without color formation or other visible signs of biocide degradation. Depending on the polymer selected, residence times as long as 30 minutes have been utilized without decomposition of the biocide. Finally, the carrier/biocide combination formed in Example 1 can also be utilized directly with an appropriate dilution to prepare polymer loaded with biocide without utilizing the polymer masterbatch pellet material.

### Example 4

### Preparation of Silica Loaded with an Antibiotic

About 80 parts of a methanolic suspension containing about 70% wt. % penicillin is combined with about 40 parts of fumed silica (SiO₂). The moist combination is mixed for about 5 minutes at ambient temperature in a high speed mixer at approximately 1200 rpm to provide a flowable powder. The resulting methanol wet carrier/quaternary salt can be incorporated into a polymer directly or dried before further use.

This method can be used to prepare further carrier/antibiotic combinations utilizing silica and, amoxicillin, campicillin, piperacillin, carbenicillin indanyl, methacillin cephalosporin cefaclor, streptomycin, tetracycline and the like. Additionally, the method described above can also be utilized to prepare other carrier/biocide combinations utilizing the carriers including clay; kaolin; perlite bentonite; talc; mica; calcium carbonate; titanium dioxide; zinc oxide; and iron oxide.

### Example 5

### The Incorporation of a Carrier/Antibiotic Combination into a Polymer Masterbatch and Polymer Container

The procedure described in Example 2 can be utilized to prepare antibiotic loaded polymer masterbatch pellets and the procedure described in Example 3 can be utilized to prepare antibiotic loaded polymer containers from the masterbatch pellets containing an antibiotic. Finally, the carrier/antibiotic combination can also be utilized directly with an appropriate dilution to prepare polymer loaded with antibiotic without utilizing the polymer masterbatch pellet material.

### Example 6

### Biological Tests

ASTM E 2180, the standard method for determining the activity of incorporated antimicrobial agents in polymers or hydrophobic material, was utilized to test untreated sheets of polypropylene and sheets of polypropylene containing 1% N,N-didecyl-N-methyl-N-(3-trimethoxysilylpropyl)ammonium chloride prepared according to the procedure described in Example 3 above. The samples were tested by pipetting a thin layer of inoculated agar slurry [Klebsiella Pneumoniae ATCC#4352, and Staphylococus aureus ATCC#6538] onto the untreated sheets and onto the treated sheets. Testing was carried out in triplicate. After 24 hours of contact at 35° C., surviving microorganisms were recovered into neutralizing broth. Serial dilutions were made, and bacterial colonies from each dilution series were counted and recorded. Percent reduction of bacteria from treated versus untreated samples were calculated.

The geometric mean of the number of organism recovered from the triplicate incubation period control and incubation period treated samples were calculated and the percent reduction was determined by the following formula:

$$\% reduction = \frac{a - b}{a} \times 100$$

where a=the antilog geometric mean of the number of organisms recovered from the incubation period control sample; and

b=the geometric mean of the number of organisms recovered from the incubation period treated samples.

The results are provided in Table I provided below:

TABLE I

| Sample | | Count | Percent |
|---|---|---|---|
| Identification | Microorganism | (Avg)* | Reduction (%) |
| untreated | K. pneumoniae | 1.43 × 10⁷ | — |
| treated | K. pneumoniae | 1.49 × 10⁶ | 89.58 |
| untreated | S. aureus | 3.1 × 10⁶ | — |
| treated | S. aureus | 8.5 × 10⁵ | 72.6 |

*Ave = Average of the triplicate values

The heat labile biocides described above can be similarly incorporated into the polymers described herein to provide polymer/biocide combinations which are capable of retarding the growth of microorganisms including, but not limited to E. coli, MRSA, Clostridium difficile, Aspergillus niger, and H1N1 Influenza A virus.

The examples provided above illustrate how the component/carrier technology can be used to provide polymers exhibiting properties derived from the added component. Utilizing this technology, a range of component/carrier combinations can be utilized to prepare a range of polymers with new properties. The polymers taught herein can be transformed into containers, or container surfaces utilizing standard polymer processing methods, including, but not limited to molding, extrusion, lamination, polymer fabrication, the application of surface treatments, and the like.

The present invention contemplates modifications as would occur to those skilled in the art. It is also contemplated that a variety of materials incapable of surviving intimate contact with a molten phase at elevated temperatures can survive such processing by first being incorporated into an appropriate carrier material as disclosed herein, and that such variation of the present disclosure might occur to those skilled in the art without departing from the spirit of the present invention. All publications cited in this specification are herein incorporated by reference as if each individual publication was specifically and individually indicated to be incorporated by reference and set forth in its entirety herein.

Further, any theory of operation, proof, or finding stated herein is meant to further enhance understanding of the present invention and is not intended to make the scope of the present invention dependent upon such theory, proof, or finding. While the invention has been illustrated and described in detail in the figures and foregoing description, the same is considered to be illustrative and not restrictive in character, it being understood that only the preferred embodiments have been shown and described and that all changes and modifications that come within the spirit of the invention are desired to be protected.

What is claimed is:

1. A water container having a surface comprising a combination including a polymer having a melting temperature and a heat labile component adsorbed on a carrier, the heat labile component having a decomposition temperature, wherein: (a) the polymer's melting temperature is greater than the heat labile component's decomposition temperature, and (b) the surface was formed by processing the combination at the polymer's melting temperature without decomposition of the heat labile component.

2. The water container of point 1, wherein the heat labile component is a heat labile biocide.

3. The water container of point 2, wherein the heat labile biocide is a quaternary amine derivative and the polymer's melting temperature is ≧180° C.

4. The water container of point 1, wherein the heat labile component is a biocide selected from the group consisting of a bactericide, a fungicide, an algicide, a miticide, a viruscide, an insecticide, a herbicide, a repellent, and combinations thereof.

5. The water container of point 1, wherein the polymer is selected from the group consisting of a polyvinylchloride, a thermoplastic elastomer, a polyurethane, a high density polyethylene, a low density polyethylene, a silicone polymer, a fluorinated polyvinylchloride, a polystyrene, a styrene-acrylonitrile resin, a polyethylene terephthalate, a rayon, a styrene ethylene butadiene styrene rubber, a cellulose acetate butyrate, a polyoxymethylene acetyl polymer, a latex polymer, a natural rubber, a synthetic rubber, an epoxide polymer (including powder coats), and a polyamide.

6. The water container of point 1, wherein the heat labile component is heat labile because of its volatility.

7. The water container of point 1, wherein the heat labile component is a fragrance.

8. A method for preparing a water container having a surface including a polymer, a heat labile component, and a carrier comprising:
(a) providing a mixture including a polymer and a heat labile component adsorbed on a carrier, wherein the polymer has a melting temperature, the heat labile component has a decomposition temperature;
(b) subjecting the mixture to a processing temperature for a time sufficient to form a melt containing the polymer and the heat labile component adsorbed on the carrier; and
(c) cooling the melt to form the surface to the polymer and the heat labile component adsorbed on the carrier, wherein,
the processing temperature is ≧the melting temperature of the polymer;
the processing temperature is greater than the heat labile component's decomposition temperature; and
the heat labile component adsorbed on the carrier is distributed across the surface of the polymer, the heat labile component, and the carrier.

9. The method of point 8, wherein the heat labile component provided is a heat labile biocide.

10. The method of claim 9, wherein the heat labile biocide is a quaternary amine derivative and the polymer's melting temperature is ≧180° C.

11. The method of point 9, wherein the heat labile biocide provided is selected from the group consisting of a bactericide, a fungicide, an algicide, a miticide, a viruscide, an insecticide, a herbicide, repellent, and combinations thereof.

12. The method of point 8, wherein the polymer provided is selected from the group consisting of a polyvinylchloride, a thermoplastic elastomer, a polyurethane, a high density polyethylene, a low density polyethylene, a silicone polymer, a fluorinated polyvinylchloride, a polystyrene, a styrene-acrylonitrile resin, a polyethylene terephthalate, a rayon, a styrene ethylene butadiene styrene rubber, a cellulose acetate butyrate, a polyoxymethylene acetyl polymer, a latex polymer, a natural rubber, a synthetic rubber, an epoxide polymer (including powder coats), and a polyamide.

13. A method for forming a water container having a surface containing a plurality of components adsorbed onto a plurality of carriers, the method comprising:
(a) providing a molten phase of the polymer at a liquid processing temperature;
(b) adding a plurality of components adsorbed on a plurality of carriers to the molten phase to provide a molten mixture, wherein at least one component is incompatible;
(c) subjecting the molten mixture to the processing temperature for a processing time sufficient to form a homogeneous molten phase containing the plurality of components; and
(d) cooling the molten phase to form a solid containing the plurality of components distributed throughout, including the member's surface, wherein the incompatible component is incompatible with either another component or the polymer.
